(19) United States
(12) Patent Application Publication
(10) Pub. No.: US 2004/0145540 A1
(43) Pub. Date: Jul. 29, 2004

(54) Image display apparatus

(76) Inventor: Takahiro Amanai, Sagamihara-shi (JP)

Correspondence Address: KENYON & KENYON, Suite 700, 1500 K Street, N.W., Washington, DC, 20005, US

(21) Appl. No.: 10/644,785

(22) Filed: Aug. 21, 2003

(30) Foreign Application Priority Data
Jul. 13, 2001 (JP) 2001-213283

(51) Int. Cl. G09G 5/00

(52) U.S. Cl. 345/8

(57) ABSTRACT

A private image display apparatus includes a display element that displays a picture, a projecting optical system that projects the picture, and a diffusive hologram screen that is disposed on the imaging position of a real image projected by the projecting optical system and that has a predetermined directionality. The private image display apparatus is configured to satisfy the condition 0.01<Y/D<2.7, to thereby introduce the picture displayed on the display element exclusively into the pupil of an operator without introducing it into a person other than the operator, where D is a distance from the diffusive hologram screen to the eye of the operator and Y is a diameter of an observable region.

### BACKGROUND OF THE INVENTION

1. Field of the Invention The present invention relates to an image display apparatus, specifically to a handheld- type, private image display apparatus.

2. Description of the Related Art

In recent years, cellular phone, personal data assistant, ATM machine, and the like have been required to allow a user to observe an image containing secret information displayed on their image display surfaces without the image being viewed by others. If the requirement should be fulfilled, one could use with confidence such an apparatus in public, such as in a train.

An apparatus to satisfy such a requirement has been proposed in Japanese Patent Application Preliminary Publication (KOKAI) No. Hei 5-88020. FIG. 1 shows one example of such a private image display apparatus. In the apparatus of FIG. 1, an image is projected on a reflection-type diffraction hologram screen 21 from a projecting unit 22. Here, the reflection-type diffraction hologram screen 21 is provided with a characteristic such as to diffract light with directionality. Whereby, only an operator A can view the displayed image, while a person other than the operator A cannot view the displayed image. Consequently, image observation with high secrecy can be achieved.

### SUMMARY OF THE INVENTION

The present invention provides a private image display apparatus that includes a display element for displaying a picture, a projecting optical system for projecting a real image of the picture, and a reflection-type, diffusive hologram screen disposed at the position of the real image or in the vicinity thereof, wherein the reflection-type, diffusive hologram screen has a predetermined directionality, which makes it possible, when an operator uses the apparatus held in hand, to introduce the picture displayed on the display element exclusively into the pupil of the operator.

Also, the present invention provides a personal data assistant that includes the above-mentioned private image display apparatus, operation buttons via which an operator inputs/outputs data from the external, a data processor connected with the operation buttons, a storage device connected with the data processor, and a transceiver unit connected with the data processor.

Also, the present invention provides a cellular phone that includes the above-mentioned private image display apparatus, operation buttons via which an operator inputs/outputs data from the external, an audio input unit for inputting audio data derived from the operator, and an audio output unit for outputting audio data transmitted from the mate correspondent.

The features and advantages of the present invention will become apparent from the following detailed description of the preferred embodiments when taken in conjunction with the accompanying drawings.

### BRIEF DESCRIPTION OF THE DRAWINGS

FIG. 1 is a diagram that shows one example of the conventional private image display apparatus.

FIG. 2 is a diagram to show a characteristic of a diffusive hologram screen used in the present invention.

FIG. 3 is a configuration diagram of an exposure optical system used for fabricating a reflection-type, diffusive hologram screen.

FIG. 4 is a diagram that shows the first embodiment of the private image display apparatus according to the present invention.

FIG. 5 is a configuration diagram of an exposure optical system used for fabricating a transmission-type, diffusive hologram screen.

FIG. 6 is a diagram that shows the second embodiment of the private image display apparatus according to the present invention.

FIG. 7 is a diagram that shows the third embodiment of the private image display apparatus according to the present invention.

FIG. 8 is a configuration diagram of an exposure optical system used for fabricating a reflection-type, diffusive hologram screen used in the third embodiment of the present invention.

FIG. 9 is a diagram that shows the fourth embodiment of the private image display apparatus according to the present invention.

FIG. 10 is a diagram that shows the fifth embodiment of the private image display apparatus according to the present invention.

FIG. 11 is a schematic diagram that shows one example of the personal data assistant using the private image display apparatus according to the present invention.

FIG. 12 is a schematic diagram that shows another example of the personal data assistant using the private image display apparatus according to the present invention.

FIG. 13 is a schematic diagram that shows one example of the cellular phone using the private image display apparatus according to the present invention.

FIG. 14 is a schematic diagram that shows another example of the cellular phone using the private image display apparatus according to the present invention.

FIG. 15 is an explanatory diagram that shows a situation where the apparatus shown in one of FIGS. 11-14 is in use by an operator.

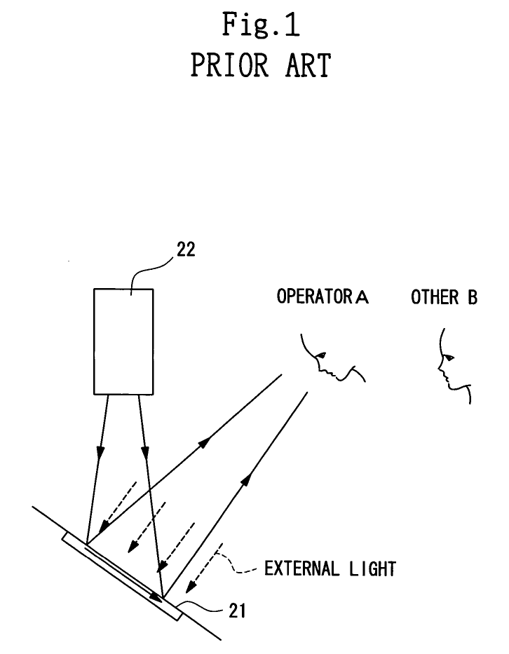

### DETAILED DESCRIPTION OF THE PREFERRED EMBODIMENTS

Preceding explanation of the embodiments of the present invention, the function of the present invention is described.

The private image display apparatus according to the present invention includes a display element that displays a picture and a projecting optical system that projects the picture. Here, at the imaging position of the real image projected by the projecting optical system, a diffusive hologram screen is arranged. The diffusive hologram screen may be a transmission-type or reflection-type one.

It is noted that the diffusive hologram screen is given a characteristic of having a predetermined directionality. Resultantly, when used as handheld by an operator, it can introduce the picture displayed on the display element exclusively into the pupil of the operator without introducing the same to the pupil of any person other than the operator.

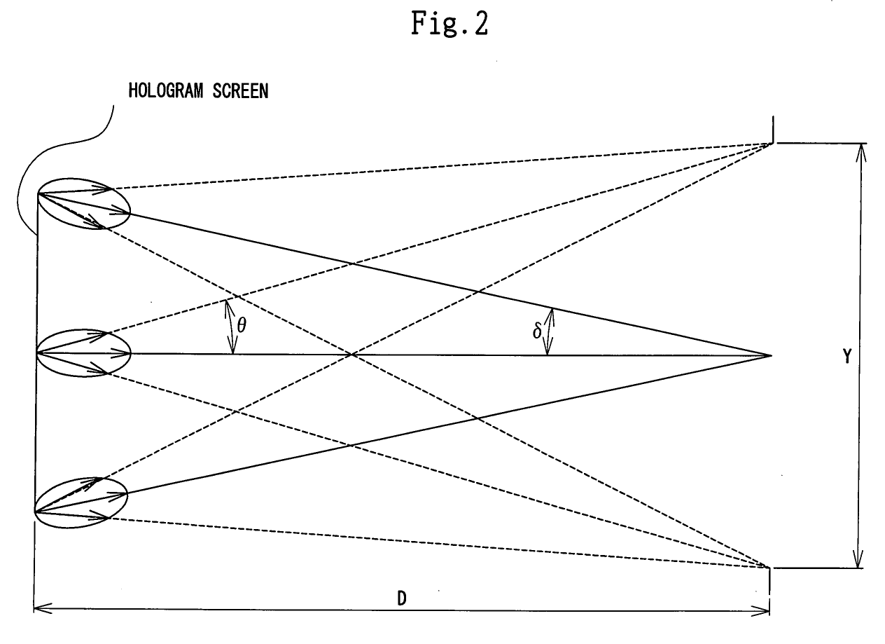

FIG. 2 is a diagram to show a characteristic of a diffusive hologram screen used in the present invention. Here, it supposes a situation where an operator uses the private image display apparatus as holding it in hand. Thus, the distance D appearing in FIG. 2 has a value with which use in the above-described situation is practical.

In order to achieve observation easily via a handheld-type, private image display apparatus while keeping secrecy, it is preferable to satisfy the following condition (1):

0.01<Y/D<2.7 (1)

where D is an observation distance from the diffusive hologram screen to the eye of the operator, and Y is a diameter of the observable region.

If a value of Y/D is smaller than the lower limit of Condition (1), the observable region Y becomes too narrow. As a result, when shake occurs as the apparatus is held in hand, the image is eclipsed even for a single eye, to prevent smooth viewing. Otherwise, the observation distance D becomes too far for a handheld-type, private image display apparatus.

On the other hand, if a value of Y/D exceeds the upper limit of Condition (1), the observable region Y becomes too wide. As a result, secrecy fails. Otherwise, the observation distance D becomes so close as to make it difficult to focus on the image.

Furthermore, it is desirable to satisfy the following condition (2):

0.02<Y/D<2.4 (2)

The significance of the upper and lower limits of Condition (2) is same as that of Condition (1).

Furthermore, it is desirable to satisfy the following condition (3):

0.05<Y/D<2.0 (3)

The significance of the upper and lower limits of Condition (3) is same as that of Condition (1).

It is preferred that a handheld-type image display apparatus allows for shake as held in hand and permits the operator alone to make observation. To this end, it is desirable to satisfy the following condition (4):

0.3 deg. <θ<54.0 deg. (4)

where θ is a value of full width at half maximum in a graph presenting the diffusion characteristic of the diffusive hologram screen.

The diffusion characteristic is presented as a certain curve (graph) in a coordinate system of diffusion angle taken along the abscissa by light intensity taken along the ordinate. This curve often is substantially mirror-symmetric with respect to a certain diffusion angle (for example, 0 deg.) . In this case, there are two diffusion angles at which intensity is half the maximum. Thus, full width at half maximum is defined as a width between these two points. This value signifies an angular range of diffusion presented as this width, as a matter of course. The diffusion characteristic need not necessarily be provided with symmetry.

If θ is smaller than the lower limit of Condition (4), the observable region becomes too narrow. As a result, in image observation, the display surface is eclipsed or so to prevent smooth viewing.

On the other hand, if θ exceeds the upper limit of Condition (4), the observable region becomes too wide. As a result, a person other than the operator can make observation, and secrecy fails.

Furthermore, it is desirable to satisfy the following condition (5):

0.8 deg. <θ<51.0 deg. (5)

The significance of the upper and lower limits of Condition (5) is same as that of Condition (4).

Furthermore, it is desirable to satisfy the following condition (6):

1.0 deg. <θ<45.0 deg. (6)

The significance of the upper and lower limits of Condition (6) is same as that of Condition (5).

Also, in the handheld-type, private image display apparatus, it is preferable that image observation with uniform and bright light is achieved over the entire display surface. To this end, it is important to satisfy the following condition (7):

0.3 deg. <δ<54.0 deg. (7)

where δ is an angle formed by a direction in which a diffusion characteristic at a center of the diffusive hologram screen is maximum and a direction in which a diffusion characteristic at a peripheral position farthest from the center of the diffusive hologram screen is maximum.

In order to make uniform brightness over the entire display surface, it is important that the angle δ coincides with the field angle.

If the angle δ is smaller than the lower limit of Condition (7), uniform brightness over the entire display surface cannot be obtained unless the image display region is designed to be extremely small. Alternatively, uniform brightness over the entire display surface cannot be obtained unless the observing position is shifted farther from the screen. As a result, it goes beyond the normal application as a handheld-type, image display apparatus, and thus causes difficulty in handling.

On the other hand, if the angle δ exceeds the upper limit of Condition (7), uniform brightness over the entire display surface cannot be obtained unless the image display region is designed to be large. Alternatively, uniform brightness over the entire display surface cannot be obtained unless the observing position is shifted closer to the screen. As a result, it goes beyond the normal application as a handheld-type, image display apparatus, and thus causes difficulty in handling.

Furthermore, it is desirable to satisfy the following condition (8):

0.8 deg. <δ<51.0 deg. (8)

The significance of the upper and lower limits of Condition (8) is same as that of Condition (7).

Furthermore, it is desirable to satisfy the following condition (9):

1.0 deg. <δ<45.0 deg. (9)

The significance of the upper and lower limits of Condition (9) is same as that of Condition (7).

It is noted that the diffusive hologram screen according to the present invention is constructed of a volume hologram (HOE) provided with light diffusing function. The manufacture method of the HOE is described below.

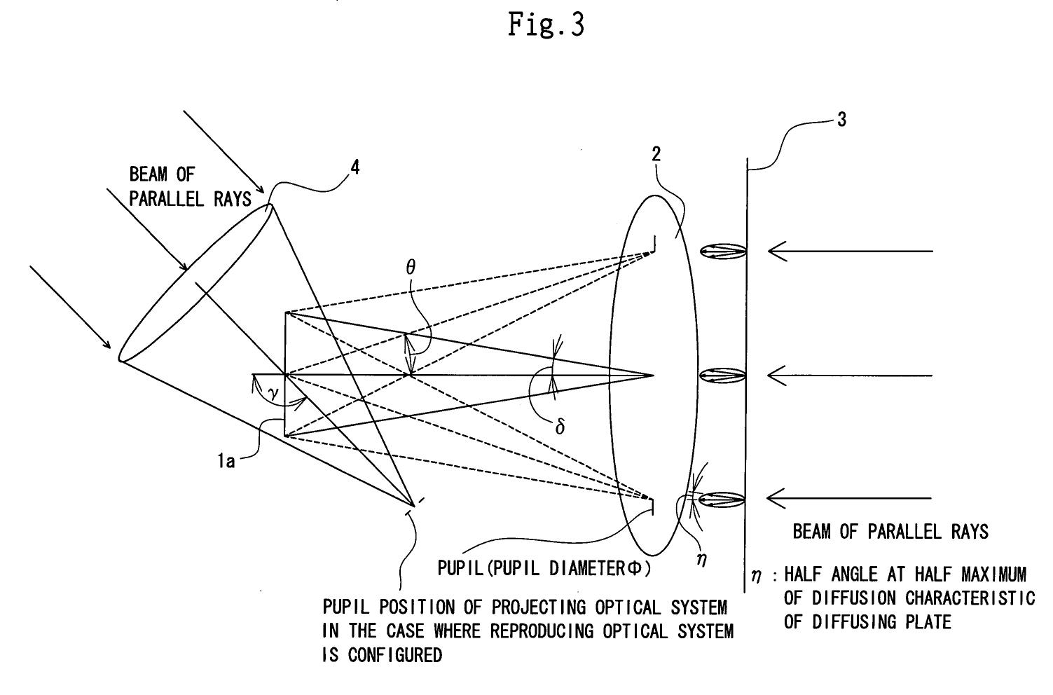

FIG. 3 is a configuration diagram of an exposure optical system prepared for fabricating a reflection-type, diffusive hologram screen. The reference numeral 1a denotes an optical member having photosensitivity, to be ultimately turned into a volume hologram (HOE). The reference numeral 2 denotes a first lens system, disposed to oppose the optical member 1a. Here, the distance between the optical member 1a and the second lens 2 is equal to the focal length of the second lens 2. The reference numeral 3 denotes a diffusing plate, disposed between a first light source not shown and the first lens system 2.

The reference numeral 4 denotes a second lens system, disposed so that the optical member 1a is interposed between it and the first lens system 2. The second lens system 4 is arranged to be tilted in reference to the first lens system 2 and the optical member 1a. Also, a second light source not shown is arranged so that light reaches the optical member 1a via the second lens system 4.

In this configuration, a beam of parallel rays from the first light source not shown is made to be incident on the diffusing plate 3, directed toward the optical member (volume hologram) 1a. The beam of parallel rays incident on the diffusing plate 3 is diffused at the diffusing surface. The diffused light passes the first lens system 2, to reach the optical member 1a.

Here, it is desirable to satisfy θ= tan⁻¹ (φ/2f), where the pupil diameter of the first lens system 2 is φ, and the focal length of the first lens system 2 is f. In addition, it is desirable that the angle δ satisfies δ=η, where η is half angle at half maximum of the diffusion characteristic of the diffusing plate 3.

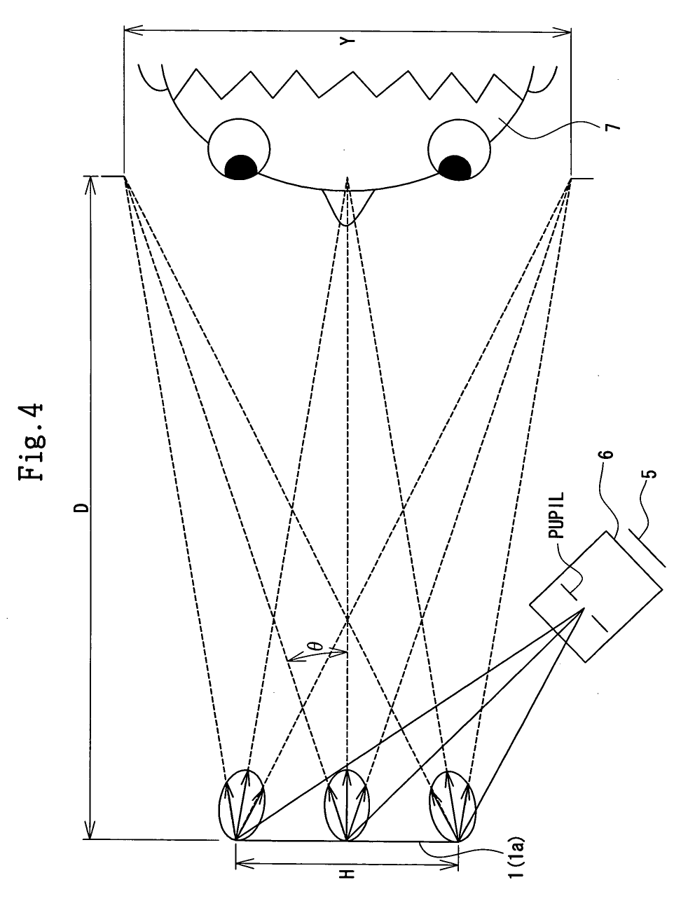

On the other hand, a beam of parallel rays from the second light source, which is not shown, also is made to be incident on the second lens system 4. The beam of parallel rays incident on the second lens system 4 converges on the focal position of the second lens system 4. The light convergence position coincides with the pupil position of the projecting optical system shown in FIG. 4. Also, the position and tilt of the second lens system are arranged so that the beam of convergent rays directed toward the light convergence position passes the optical member 1a.

In this way, for fabricating a reflection-type, diffusive hologram screen, arranging the first lens system 2 on one side and the second lens system 4 on the other side with respect to the optical member 1a interposed between can achieve the object.

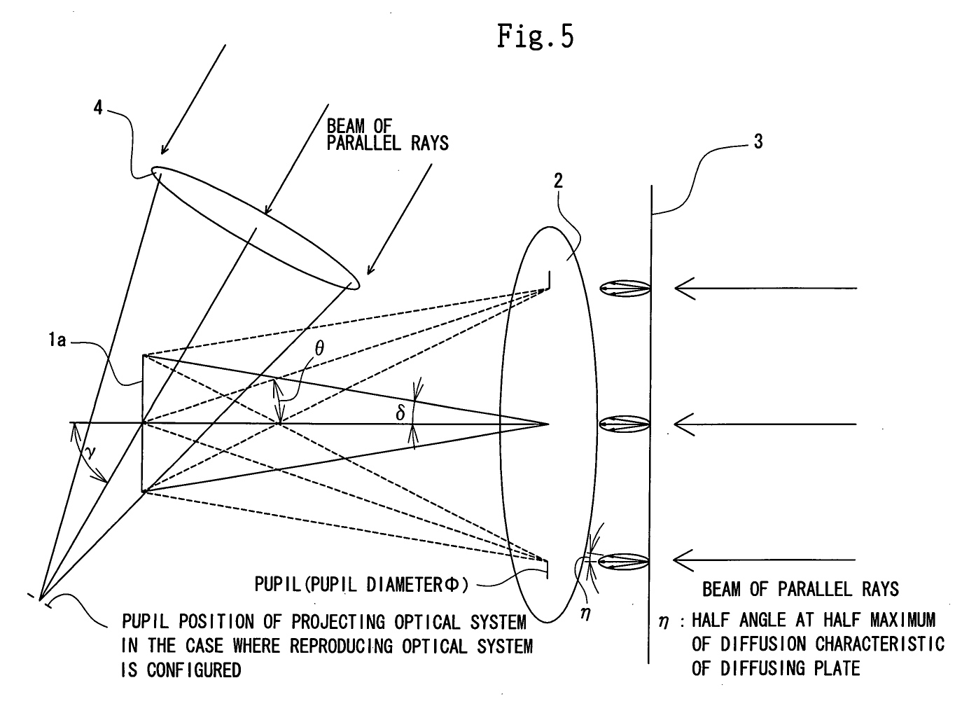

Also, for fabricating a transmission-type, diffusive hologram screen, the configuration shown in FIG. 5 works. To be specific, the first lens system 2 and the second lens system 4 should be arranged on one side with respect to the optical member 1a, with the light convergence position of the second lens system 4 being arranged opposite to the side where the first lens system 2 and the second lens system 4 are arranged.

In this case, the position and tilt of the second lens system are arranged so that the beam of convergent rays directed toward the light convergence point passes the optical member 1a. Also, the light convergence position of the second lens system coincides, not like the light convergence position of the first lens system 1, with the pupil position of the projecting optical system.

The method of fabricating diffusive hologram screens of reflection type and transmission type is explained above. In a diffusive hologram screen thus fabricated, a region where the emergent beam of rays from the first lens system 2 overlaps the emergent beam of rays from the second lens system 4 becomes an image display region. In the exposure optical system, it is desirable that the distance from the optical element 1a to the light convergence position of the second lens system is equal to the distance from the image display region to the pupil position of the projecting optical system.

In a case where a color diffusive hologram screen is fabricated, light with at least three wavelengths such as R, G, B is required as exposure light. Also, the optical member 1a is required to have the characteristic of photosensitive to these three wavelengths, that is, the characteristic of having a broad photosensitive region. A single optical member 1a that has a broad photosensitive region is exposed with light having these three wavelengths, to make up a color diffusive hologram screen.

Alternatively, an optical member having a photosensitive region selective for R, an optical member having a photosensitive region selective for G, and an optical member having a photosensitive region selective for B may be used. In this case, The optical members are exposed with respective wavelengths of light. Then, these optical members are cemented together, to make up a color diffusive hologram screen.

The manufacture method of the diffusive hologram screen is explained above. The private image display apparatus according to the present invention is provided with a diffusive hologram screen fabricated by such a method. Thus, a diffusive hologram screen of either of the reflection type and the transmission type is applicable to the private image display apparatus according to the present invention.

In addition, the private image display apparatus is provided with a projecting optical system. The projecting optical system may be constructed of an optical element having a free-formed surface.

A screen surface of the diffusive hologram screen constructed of a plane surface can be more easily fabricated. However, it may be constructed of a curved surface. Such a configuration makes it possible to compensate for distortion or curvature of field of the observed image.

Also, in the private image display apparatus, the diffusive hologram screen may be tilted in reference to the observer so that the screen surface is substantially perpendicular to the axial chief ray of the projecting optical system. Such a configuration makes it possible to compensate for trapezoidal distortion of the observed image.

The embodiments of the present invention are explained below in reference to the drawings.

First Embodiment

FIG. 4 shows the first embodiment of the private image display apparatus according to the present invention. In the private image display apparatus of this embodiment, a reflection-type, diffusive hologram screen is used. In reference to FIG. 4, reproduction of an image is achieved by the reflection-type, diffusive hologram screen. Thus, FIG. 4 can be referred to as a diagram to show a reproducing optical system.

On the other hand, FIG. 3 shows a configuration formed when the reflection-type, diffusive hologram screen used in the first embodiment is fabricated. In reference to FIG. 3, an optical member 1a is subject to exposure, to fabricate the reflection-type, diffusive hologram screen 1. Thus, FIG. 3 can be referred to as a diagram to show an exposure optical system.

The private image display apparatus of this embodiment is a handheld-type apparatus. According to this embodiment, the angle of shake allowed for is within ten degrees. In addition, the private image display apparatus is configured to allow observation by both eyes.

As shown in FIG. 4, the private image display apparatus includes a display element 5 that displays a picture, a projecting optical system 6 that projects the picture, and a reflection-type, diffusive hologram screen 1. According to this embodiment, the diffusive hologram screen 1 is a reflection-type one. Consequently, the display element 5 and the projecting optical system 6 are arranged on one side with respect to the reflection-type, diffusive hologram screen 1, that is, on the same side as an operator 7.

The projecting optical system 6 is composed of optical elements (not shown) such as lenses. The projecting optical system 6 projects, on a predetermined position, the picture displayed on the display element 5. On this predetermined position, a real image of the picture is formed.

The reflection-type, diffusive hologram screen 1 is disposed on this predetermined position or in the vicinity thereof. The reflection-type, diffusive hologram screen 1 has a predetermined directionality. Also, a screen surface of the diffusive hologram screen 1 is formed as a plane surface.

The projecting optical system 6 is arranged in the following manner in reference to the reflection-type, diffusive hologram screen 1. That is, the projecting optical system 6 is arranged so that the pupil position of the projecting optical system 6 coincides with a focal position of the second lens system 4 shown in FIG. 3.

In the private image display apparatus of this embodiment, light from the display element 5 is enlarged via the projecting optical system 6, to be incident on the reflection-type, diffusive hologram screen 1. Then, the light is diffracted and diffused, as well as reflected, at the reflection-type, diffusive hologram screen 1. The reflected light then reaches the pupil position of the operator 7.

In this event, the light from the reflection-type, diffusive hologram screen 1 is limited with respect to the angular range of diffusion. Therefore, light reaching the pupil position of the operator 7 is within the range of the observable region Y. That is, image forming of the picture displayed on the display element 5 occurs within the observable region Y. Consequently, this embodiment can prevent a person other than the operator 7 from observing the picture displayed on the display element 5.

The numerical data of the first embodiment are shown below.

It is noted that in FIG. 3, FIG. 4 and the numerical data, φ is a pupil diameter of the first lens system 2, f is a focal length of the first lens system 2, and H is a diameter of the image circle. Also, γ is an angle formed by reference light and object light in the exposure optical system, and NA is a numerical aperture of the second lens system 4 in the exposure optical system. Also, These symbols are commonly used in the subsequent embodiments also.

Numerical data 1

φ=200 mm

f=300 mm

H=100 mm

γ=135 deg.

NA=0.35

(Values in Conditions)

Y/D=0.7

θ=18.4 deg.

δ=9.5 deg.

Second Embodiment

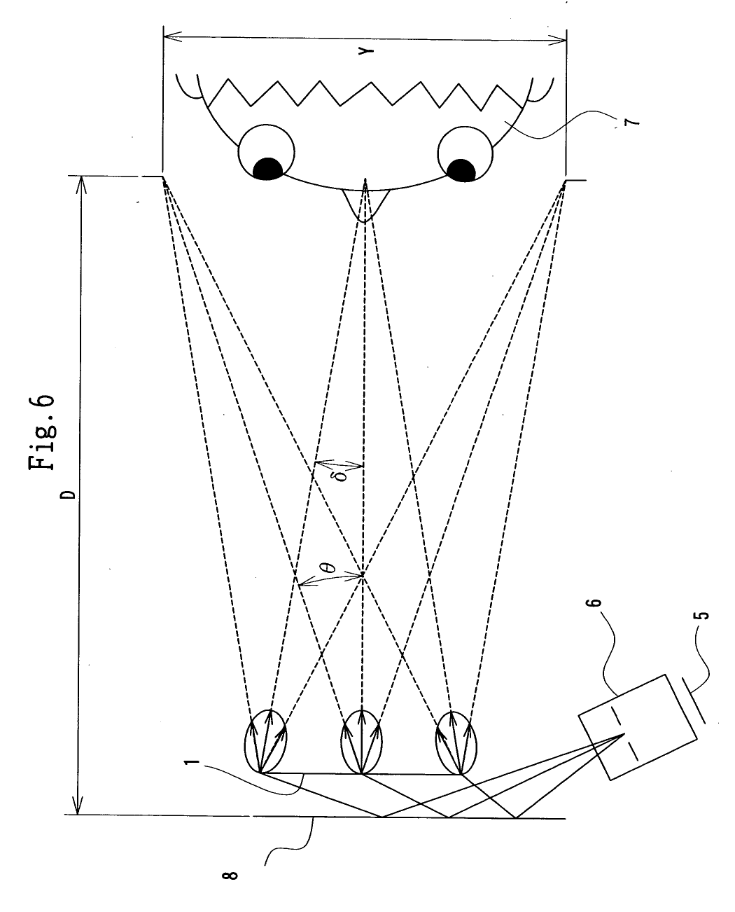

FIG. 6 shows the second embodiment of the private image display apparatus according to the present invention. In the private image display apparatus of this embodiment, a transmission-type, diffusive hologram screen is used. In reference to FIG. 6, reproduction of an image is achieved by the transmission-type, diffusive hologram screen. Thus, FIG. 6 can be referred to as a diagram to show a reproducing optical system.

On the other hand, FIG. 5 shows a configuration formed when the transmission-type, diffusive hologram screen used in the second embodiment is fabricated. In reference to FIG. 5, an optical member is subject to exposure, to fabricate the transmission-type, diffusive hologram screen 1. Thus, FIG. 5 can be referred to as a diagram to show an exposure optical system.

The private image display apparatus of this embodiment also is a handheld-type apparatus, similar to the first embodiment. According to this embodiment, the angle of shake allowed for is within ten degrees. In addition, the private image display apparatus is configured to allow observation by both eyes.

The private image display apparatus includes a display element 5 that displays a picture, a projecting optical system 6 that projects the picture, a transmission-type, diffusive hologram screen 1, and a mirror 8. According to this embodiment, the diffusive hologram screen 1 is a transmission-type one. In the case of the transmission type, the display element 5 and the projecting optical system 6 are arranged on one side with respect to the transmission-type, diffusive hologram screen 1, and an operator is positioned on the other side.

However, in the case of the handheld type, such a configuration would lessen handiness of the apparatus. Therefore, according to this embodiment, the mirror 8 is arranged on the opposite side of the operator 7 with respect to the transmission-type, diffusive hologram screen 1 interposed between. Such an arrangement is made so that light from the display element 5 is transmitted through the transmission-type, diffusive hologram screen 1 and reaches the operator 7. Thus, the display element 5 and the projecting optical system 6 are arranged on one side with respect to the transmission-type, diffusive hologram screen 1, that is, on the same side as the operator 7. Consequently, in this embodiment also, handiness is well assured as in the first embodiment.

The projecting optical system 6 is composed of optical elements (not shown) such as lenses. The projecting optical system 6 projects, on a predetermined position, the picture displayed on the display element 5. On this predetermined position, a real image of the picture is formed.

The transmission-type, diffusive hologram screen 1 is disposed on this predetermined position or in the vicinity thereof. The transmission-type, diffusive hologram screen 1 has a predetermined directionality. Also, a screen surface of the diffusive hologram screen 1 is formed as a plane surface.

The projecting optical system 6 is arranged in the following manner in reference to the transmission-type, diffusive hologram screen 1. That is, the projecting optical system 6 is arranged so that the pupil position of the projecting optical system 6 coincides with a focal position of the second lens system 4 shown in FIG. 5. It is noted that, while shown in FIG. 6, the mirror 8 is not shown in FIG. 5. Therefore, in the configuration of FIG. 5 in practice, the mirror 8 is disposed at the same position as in FIG. 6, and then the projecting optical system 6 is arranged so that the pupil of the projecting optical system 6 coincides with the focal position in this situation.

In the private image display apparatus of this embodiment, light from the display element 5 is enlarged via the projecting optical system 6, to be incident on the transmission-type, diffusive hologram screen 1. Then, the light is diffracted and diffused, as well as transmitted, at the transmission-type, diffusive hologram screen 1. The transmitted light then reaches the pupil position of the operator 7.

In this event, the light from the transmission-type, diffusive hologram screen 1 is limited with respect to the angular range of diffusion. Therefore, light reaching the pupil position of the operator 7 is within the range of the observable region Y. That is, image forming of the picture displayed on the display element 5 occurs within the observable region Y. Consequently, this embodiment can prevent a person other than the operator 7 from observing the picture displayed on the display element 5.

It is noted that, in this embodiment, the screen surface of the transmission-type, diffusive hologram screen 1 may be constructed of a curved surface. Also, the screen surface of the transmission-type, diffusive hologram screen 1 may be arranged to be tilted in reference to the operator 7, so as to be perpendicular to the axial chief ray of the projecting optical system 6.

The numerical data of the second embodiment are shown below.

Numerical data 2

φ=200 mm

f=300 mm

H=100 mm

γ=60 deg.

NA=0.25

(Values in Conditions)

Y/D=0.7

θ=18.4 deg.

δ=9.5 deg.

Third Embodiment

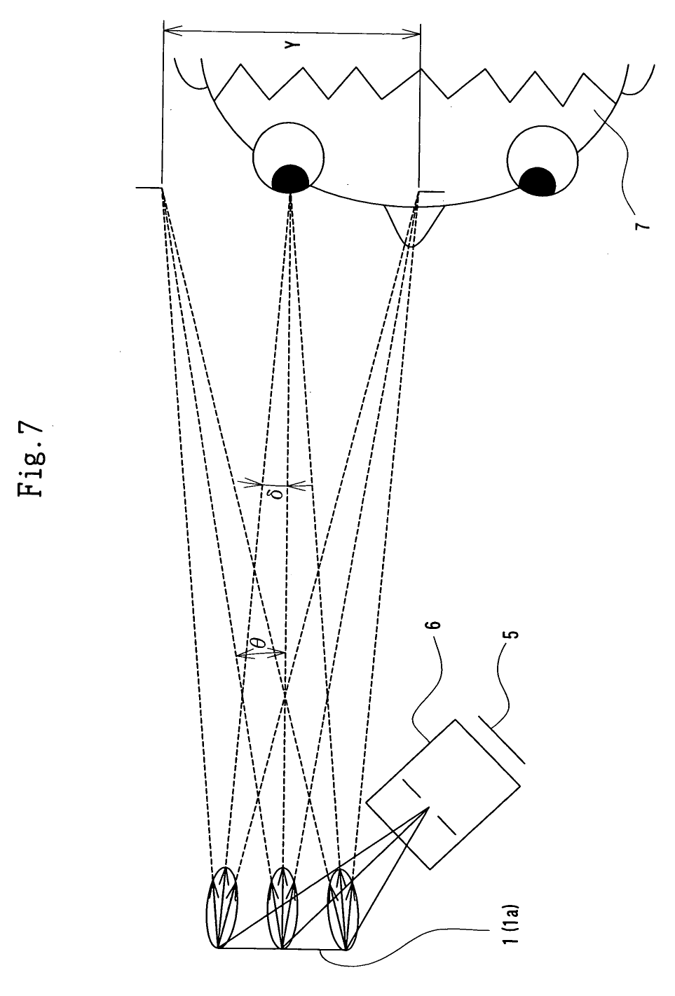

FIG. 7 shows the third embodiment of the private image display apparatus according to the present invention. In the private image display apparatus of this embodiment, a reflection-type, diffusive hologram screen is used. In reference to FIG. 7, reproduction of an image is achieved by the reflection-type, diffusive hologram screen. Thus, FIG. 7 can be referred to as a diagram to show a reproducing optical system.

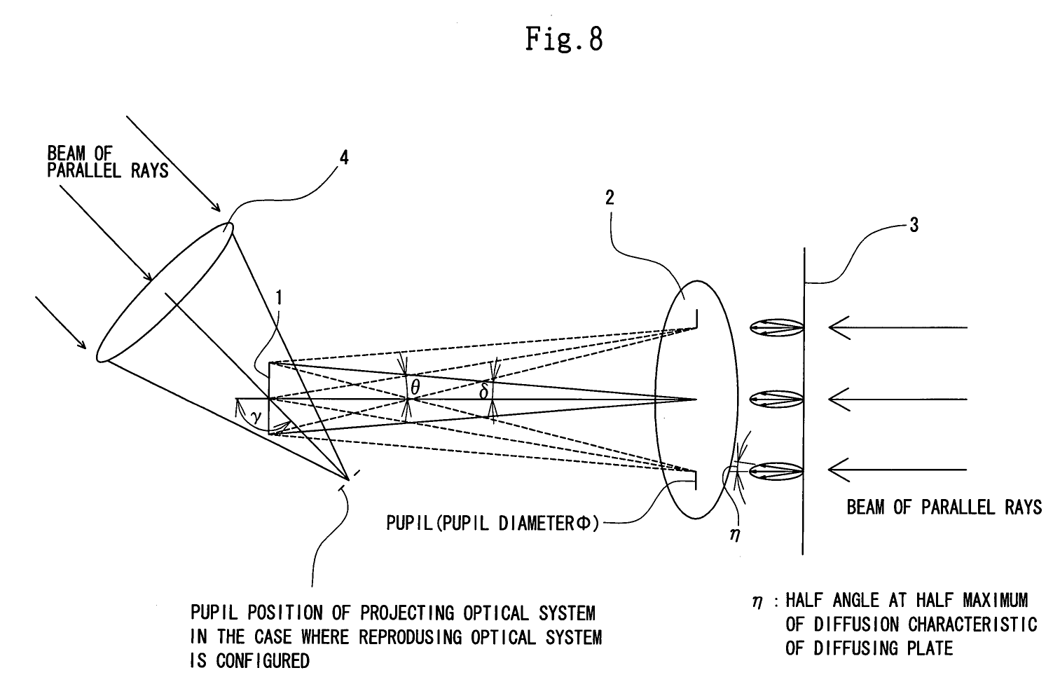

On the other hand, FIG. 8 shows a configuration formed when the reflection-type, diffusive hologram screen used in the third embodiment is fabricated. In reference to FIG. 8, an optical member is subject to exposure, to fabricate the reflection-type, diffusive hologram screen 1. Thus, FIG. 8 can be referred to as a diagram to show an exposure optical system.

The private image display apparatus of this embodiment is a handheld-type apparatus. According to this embodiment, the angle of shake allowed for is within ten degrees. In addition, the private image display apparatus is configured to allow observation by a single eye. Other basic optical configuration and function and effect of this embodiment are the same as those of the first embodiment.

The numerical data of the third embodiment are shown below.

Numerical data 3

φ=100 mm

f=300 mm

H=50 mm

γ=135 deg.

NA=0.35

(Values in Conditions)

Y/D=0.3

θ=9.5 deg.

δ=4.8 deg.

Fourth Embodiment

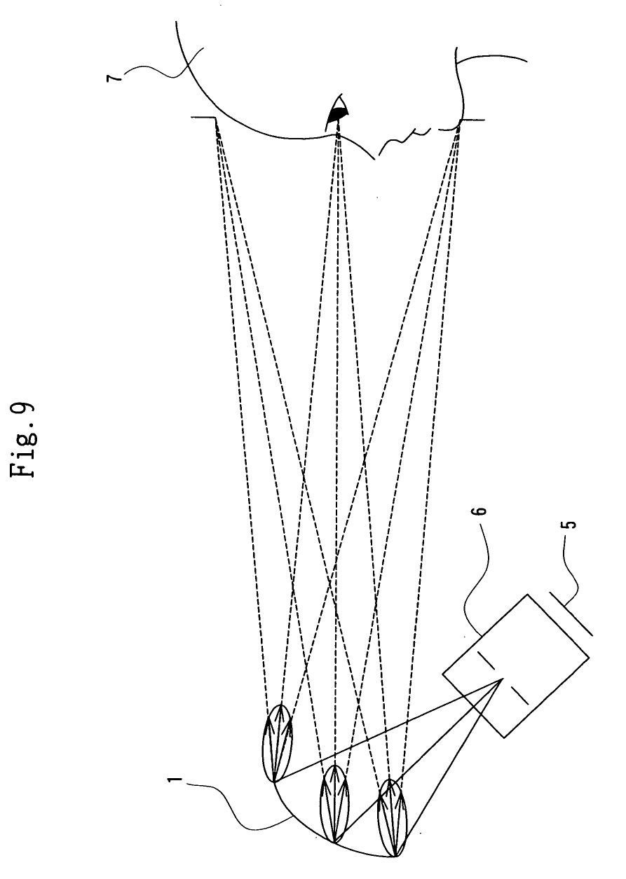

FIG. 9 shows the fourth embodiment of the private image display apparatus according to the present invention. In the private image display apparatus of this embodiment, a reflection-type, diffusive hologram screen is used. In reference to FIG. 9, reproduction of an image is achieved by the reflection-type, diffusive hologram screen. Thus, FIG. 9 can be referred to as a diagram to show a reproducing optical system.

The private image display apparatus of this embodiment is a handheld-type apparatus. Also, the private image display apparatus according to this embodiment has a configuration similar to that of the third embodiment. However, the screen surface of the reflection-type, diffusive hologram screen 1 is constructed of a curved surface.

According to this embodiment, constructing the screen surface as a curved surface makes it possible to compensate for distortion or curvature of field of the observed image. Also, since a depth of field of the eye of the operator 7 is larger than a thickness of the observed image, the observed image does not blur. In addition, it is possible to perform image observation free from distortion.

It is noted that the screen surface of the reflection-type, diffusive hologram screen 1 is constructed of a curved surface.

Fifth Embodiment

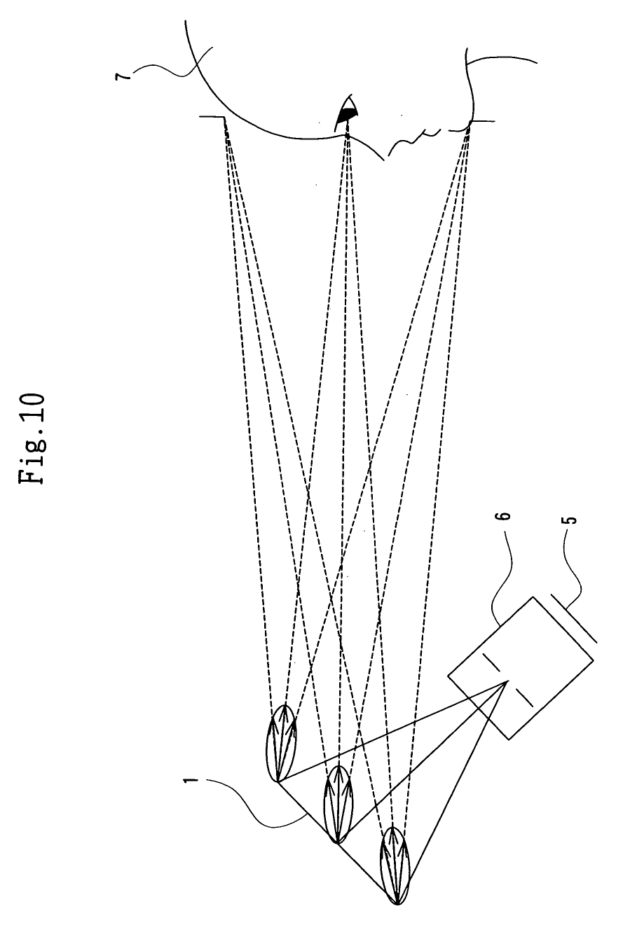

FIG. 10 shows the fifth embodiment of the private image display apparatus according to the present invention. In the private image display apparatus of this embodiment, a reflection-type, diffusive hologram screen is used. In reference to FIG. 10, reproduction of an image is achieved by the reflection-type, diffusive hologram screen 1. Thus, FIG. 10 can be referred to as a diagram to show a reproducing optical system.

The private image display apparatus of this embodiment is a handheld-type apparatus. Also, the private image display apparatus according to the embodiment has a configuration similar to that of the third embodiment. However, the screen surface of the reflection-type, diffusive hologram screen 1 is arranged to be tilted in reference to the operator so as to be perpendicular to the axial chief ray from the projecting optical system 6.

In to the private image display apparatus of this embodiment, since the screen surface is arranged to be perpendicular to the axial chief ray from the projecting optical system, trapezoidal distortion of the observed image can be compensated for. Furthermore, since the screen surface is tilted in reference to the operator 7, a depth of field of the eye of the operator 7 is larger than a thickness of the observed image. Thus, image blur does not occur. In addition, it is possible to perform image observation free from trapezoidal distortion.

It is noted that the screen surface of the reflection-type, diffusive hologram screen 1 may be constructed of a curved surface.

Furthermore, in each of the embodiments described above, the projecting optical system may include an optical element having a free-formed surface.

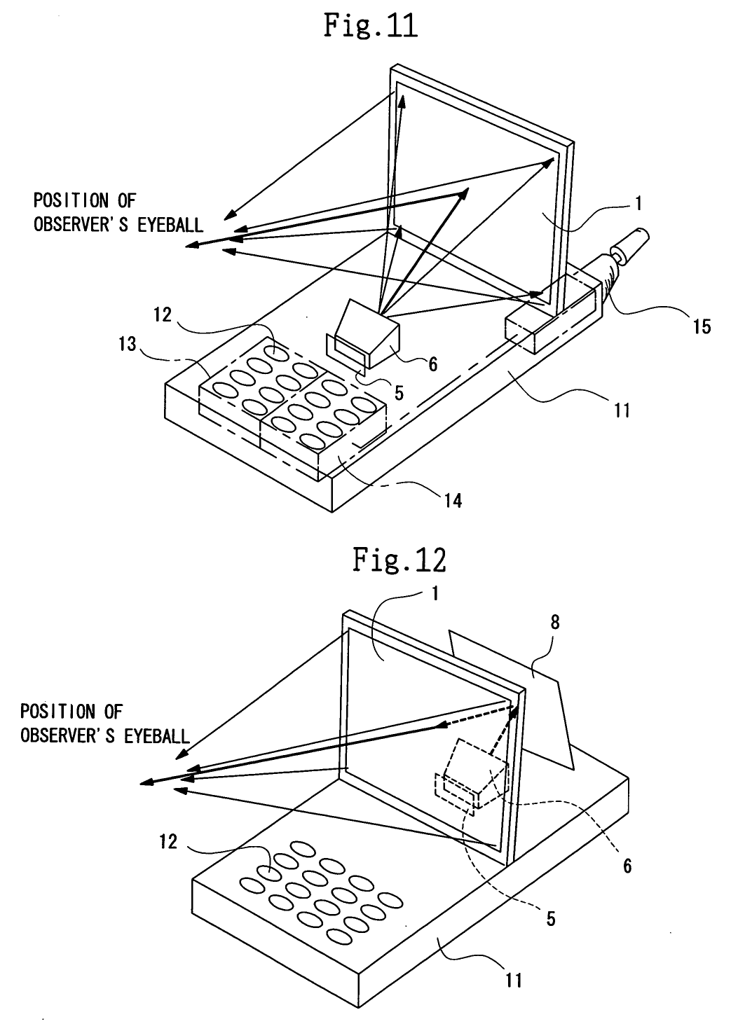

The embodiments of the private image display apparatus according to the present invention are described above. While each of these embodiments relates to a handheld-type display apparatus, the present invention is not limited to this type. Also, the private image display apparatus according to the present invention can be used as a display device of a personal data assistant or a cellular phone. Examples of application to the personal data assistant or the cellular phone are shown in FIGS. 11-15. It is noted that the term “personal data assistant” includes, not limited to a PMD, a personal computer that is usable as held in hand, such as a book-shape one.

FIG. 11 is a schematic diagram that shows one example of the private image display apparatus according to the present invention used as a part of an optical apparatus. In this example, the private image display apparatus according to the present invention is used in a personal data assistant. In FIG. 11, for illustration convenience, the position of the observer's eyeball is indicated to be close to the apparatus. In practice, however, the eyeball is at so distant a position as is practical when the personal data assistant is used as held in hand.

The personal data assistant of this embodiment is provided with an image display element 5, a projecting optical system 6, and a reflection-type, diffusive hologram screen 1 on a main body 11, which can be gripped. Also, in the drawing, the reference numeral 12 denotes operation buttons via which the operator inputs and outputs data from the external.

Also, a data processor 13, a storage device 14 such as a memory, and a transceiver unit 15 are provided as interconnected inside the main body 11. Here, as the data processor 13, a CPU or the like is used, to perform processing such as data conversion of image data or text data, communication control, and input signal control. The transceiver unit 15 transmits and receives data such as image data and text data.

Also, the reflection-type, diffusive hologram screen 1 is formed on a thin-plate-shape member edged with a frame member around. One side of the frame member is hinged (detail not shown) on the main body, to allow open/shut operation.

Regarding the private image display apparatus, of the embodiments above, a reflection-type configuration is employed. Light (picture) from the image display element 5 emergent from the projecting optical system 6 is incident on the reflection-type, diffusive hologram screen 1. The light incident on the reflection-type, diffusive hologram screen 1 is diffracted and diffused there, and further is reflected to travel toward a predetermined observable region. The predetermined observable region is a range in which the operator's eyeball is positioned.

FIG. 12 is a schematic diagram that shows another example of the private image display apparatus according to the present invention used as a part of an optical apparatus. In this example, the private image display apparatus according to the present invention is used in a personal data assistant. In FIG. 12, for illustration convenience, the position of the observer's eyeball is indicated to be close to the apparatus. In practice, however, the eyeball is at so distant a position as is practical when the personal data assistant is used as held in hand.

The personal data assistant of this embodiment is provided with an image display element 5, a projecting optical system 6, a transmission-type, diffusive hologram screen 1, and a mirror 8 on a main body 11, which can be gripped. Also, in the drawing, the reference numeral 12 denotes operation buttons via which the operator inputs and outputs data from the external.

Also, a data processor 13, a storage device 14 such as a memory, and a transceiver unit 15 are provided (not shown) inside the main body 11. Here, as the data processor 13, a CPU or the like is used, to perform processing such as data conversion of image data or text data, communication control, and input signal control. The transceiver unit 15 transmits and receives data such as image data and text data.

Also, the transmission-type, diffusive hologram screen 1 is formed on a thin-plate-shape member edged with a frame member around. One side of the frame member is hinged (detail not shown) on the main body, to allow open/shut operation.

Regarding the private image display apparatus, of the embodiments above, a transmission-type configuration is employed. Light (picture) from the image display element 5 emergent from the projecting optical system 6 is reflected at the mirror 8, to travel toward the transmission-type, diffusive hologram screen 1. The light incident on the transmission-type, diffusive hologram screen 1 is diffracted and diffused there, and then is emergent therefrom to travel toward a predetermined observable region. The predetermined observable region is a range in which the operator's eyeball is positioned.

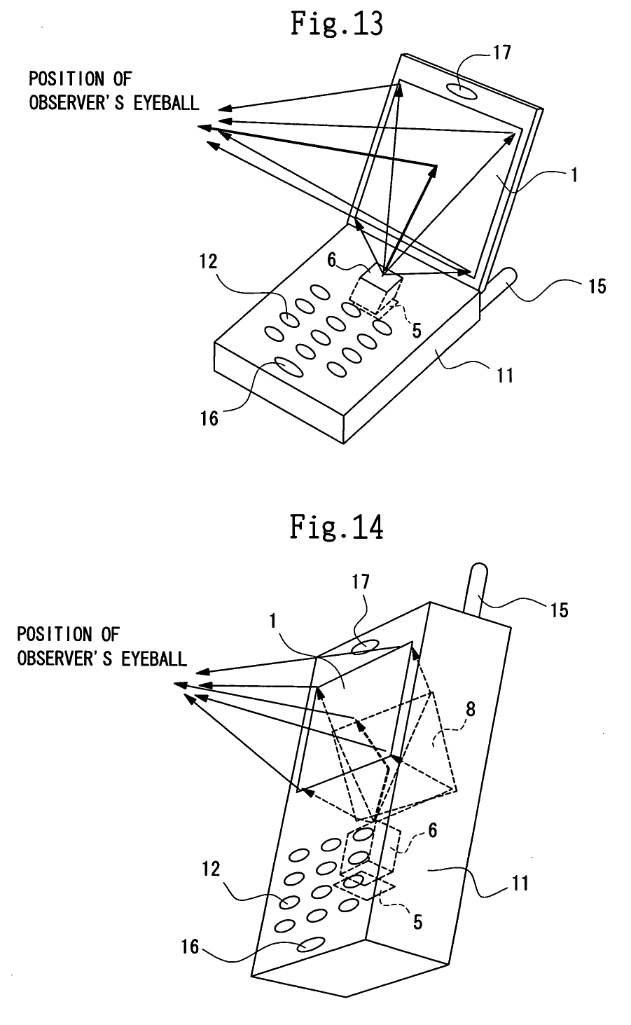

FIG. 13 is a schematic diagram that shows another example of the private image display apparatus according to the present invention used as a part of an optical apparatus. In this example, the private image display apparatus according to the present invention is used in a cellular phone. In FIG. 13, for illustration convenience, the position of the observer's eyeball is indicated to be close to the apparatus. In practice, however, the eyeball is at so distant a position as is practical when the cellular phone is used as held in hand.

The personal data assistant of this embodiment is provided with an image display element 5, a projecting optical system 6, and a reflection-type, diffusive hologram screen 1 on a main body 11, which can be gripped. Also, in the drawing, the reference numeral 12 denotes operation buttons via which the operator inputs and outputs data from the external, the reference numeral 15 denotes a transceiver unit for communication radio wave, the reference numeral 16 denotes a microphone section that inputs audio data derived from the operator, and the reference numeral 17 denotes a speaker section that outputs audio data.

Also, a data processor 13 and a storage device 14 such as a memory are provided (not shown) inside the main body 11. Here, as the data processor 13, a CPU or the like is used, to perform processing such as data conversion of image data or text data, communication control, and input signal control.

Also, the reflection-type, diffusive hologram screen 1 is formed on a thin-plate-shape member edged with a frame member around. One side of the frame member is hinged (detail not shown) on the main body, to allow open/shut operation.

Regarding the private image display apparatus, of the embodiments above, a reflection-type configuration is employed. Light (picture) from the image display element 5 emergent from the projecting optical system 6 is incident on the reflection-type, diffusive hologram screen 1. The light incident on the reflection-type, diffusive hologram screen 1 is diffracted and diffused there, and further is reflected to travel toward a predetermined observable region. The predetermined observable region is a range in which the operator's eyeball is positioned.

FIG. 14 is a schematic diagram that shows another example of the private image display apparatus according to the present invention used as apart of an optical apparatus. In this example, the private image display apparatus according to the present invention is used in a personal data assistant. In FIG. 14, for illustration convenience, the position of the observer's eyeball is indicated to be close to the apparatus. In practice, however, the eyeball is at so distant a position as is practical when the personal data assistant is used as held in hand.

The personal data assistant of this embodiment is provided with an image display element 5, a projecting optical system 6, a transmission-type, diffusive hologram screen 1, and a mirror 8 in a main body 11, which can be gripped. Also, in the drawing, the reference numeral 12 denotes operation buttons via which the operator inputs and outputs data from the external, the reference numeral 15 denotes a transceiver unit for communication radio wave, the reference numeral 16 denotes a microphone section that inputs audio data derived from the operator, and the reference numeral 17 denotes a speaker section that outputs audio data.

Also, a data processor 13 and a storage device 14 such as a memory are provided (not shown) inside the main body 11. Here, as the data processor 13, a CPU or the like is used, to perform processing such as data conversion of image data or text data, communication control, and input signal control.

Also, according to this embodiment, the projecting optical system 6 and the mirror 8 are arranged inside the main body 11, and the transmission-type, diffusive hologram screen 1 is arranged and fixed on the surface level of the main body 11.

Regarding the private image display apparatus, of the embodiments above, a transmission-type configuration is employed. Light (picture) from the image display element 5 emergent from the projecting optical system 6 is reflected at the mirror 8, to travel toward the transmission-type, diffusive hologram screen 1. The light incident on the transmission-type, diffusive hologram screen 1 is diffracted and diffused there, and then is emergent therefrom to travel toward a predetermined observable region. The predetermined observable region is a range in which the operator's eyeball is positioned.

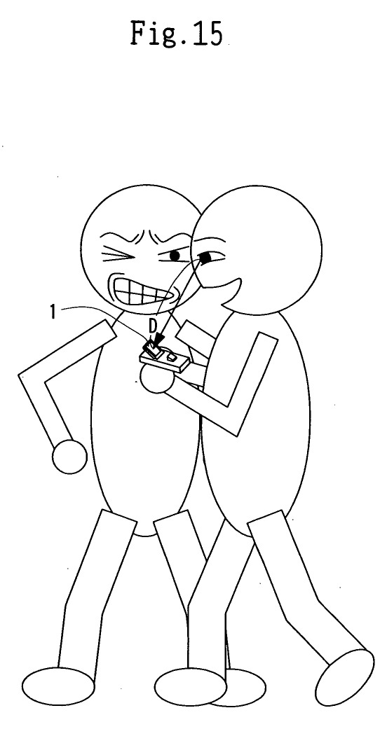

FIG. 15 is a diagram that shows a situation where the optical apparatus shown in one of FIGS. 11-14 is in use. The optical apparatus may be a personal data assistant or a cellular phone shown in FIGS. 11-14. Here, the configuration shown in FIG. 11 is employed.

When an operator uses the personal data assistant as holding it in hand, a predetermined observation distance D from the reflection-type, diffusive hologram screen to the eye of the operator is maintained. Each of the private image display apparatuses of FIGS. 11-14 satisfies Conditions (1)-(3). Therefore, the operator can keep other person from viewing the displayed image. That is, secrecy can be maintained. Moreover, it is possible to make observation without eclipse of the image.

Also, each apparatus satisfies Conditions (4)-(6). Therefore, it is possible to observe the displayed image while keeping secrecy and not being affected by shake of the apparatus as held in hand. Furthermore, each apparatus satisfies Conditions (7)-(9). Therefore, it is possible to achieve image observation with uniform brightness over the entire display surface.

What is claimed is:

1. An image display apparatus comprising:
a display element that displays a picture;
a projecting optical system that forms a real image of the picture; and
a diffusive hologram screen disposed at a position of the real image or in a vicinity thereof,
wherein the diffusive hologram screen has a predetermined directionality, to thereby introduce, when an operator uses the image display apparatus held in his hand, the picture displayed on the image display element exclusively into a pupil of the operator.

2. An image display apparatus according to claim 1, wherein the following condition is satisfied:
0.01<Y/D<2.7
where D is a distance from the diffusive hologram screen to the pupil of the operator, and Y is a diameter of an observable region.

3. An image display apparatus according to claim 1, wherein the following condition is satisfied:
0.3 deg.<θ<54.0 deg.
where θ is a value of full width at half maximum in a graph that presents a diffusion characteristic of the diffusive hologram screen.

4. An image display apparatus according to claim 1, wherein the following condition is satisfied:
0.3 deg.<δ<54.0 deg.
where δ is an angle formed by a direction in which a diffusion characteristic at a center of the diffusive hologram screen is maximum and a direction in which a diffusion characteristic at a peripheral position farthest from the center of the diffusive hologram screen is maximum.

5. An image display apparatus according to claim 1, wherein at least one of optical elements constituting the projecting optical system has a free-formed surface.

6. An image display apparatus according to claim 1, wherein the diffusive hologram screen is a reflection-type one.

7. An image display apparatus according to claim 1, wherein the diffusive hologram screen is a transmission-type one.

8. An image display apparatus according to claim 1, wherein a screen surface of the diffusive hologram screen is shaped as a plane surface.

9. An image display apparatus according to claim 1, wherein a screen surface of the diffusive hologram screen is a curved surface.

10. An image display apparatus according to claim 1, wherein the diffusive hologram screen is arranged in such a manner that a screen surface thereof is tilted in reference to the operator and is perpendicular to an axial chief ray of the projecting optical system.

11. A personal data assistant comprising:
an image display apparatus according to claim 1;
operation buttons via which the operator inputs and outputs data from an external;
a data processor connected with the operation buttons;
a storage device connected with the data processor; and
a transceiver unit connected with the data processor.

12. A cellular phone comprising:
an image display apparatus according to claim 1;
operation buttons via which the operator inputs and outputs data from an external;
an audio input unit for inputting audio data derived from the operator; and
an audio output unit for outputting audio data transmitted from a mate correspondent of the operator.
